(19) United States
(12) Patent Application Publication
(10) Pub. No.: US 2026/0222533 A1
(43) Pub. Date: Jul. 30, 2026

(54) AUTOSTEREOSCOPIC DISPLAY DEVICE CONFIGURED TO DISPLAY STEREOSCOPIC IMAGES AS A STEREOSCOPIC MOVIE

(71) Applicant: Dimenco Holding B.V., Veldhoven (NL)

(72) Inventors: Jurjen Caarls, Eindhoven (NL); Pieter Wilhelmus Theodorus de Jong, Hertogenbosch (NL)

(21) Appl. No.: 19/143,044

(22) PCT Filed: Dec. 30, 2023
(86) PCT No.: PCT/NL2023/050694

§ 371 Date: Jun. 25, 2025

(30) Foreign Application Priority Data
Dec. 30, 2022 (NL) 2033873

(51) Int. Cl. H04N 13/398; H04N 13/117; H04N 13/139; H04N 13/302; H04N 13/383

(52) U.S. Cl. CPC H04N 13/398; H04N 13/117; H04N 13/139; H04N 13/302; H04N 13/383

(57) ABSTRACT

The invention relates to an autostereoscopic display device configured to display stereoscopic images as a stereoscopic movie thereby taking into account timeline of a viewer of the autostereoscopic display device, wherein the image capture rate and the display frame rate are matched by matching means, so that both frequencies have the same value. In this way, a relation between both frequencies is enforced that does not allow that one drifts away from the other over time. In addition, a phase difference between image capture cycles and image display cycles is adapted according to the invention. This allows to reduce the time between the moment where position data become available and the moment where the position data are actually used by an application for which the position data are intended. Such adaptation of phase difference may solve problems associated with conventional autostereoscopic display devices, such as fluctuations in latency, inaccurate prediction of viewer position, position jitter, movement of displayed virtual objects and crosstalk when the viewer moves relative to the display.

### FIELD OF THE INVENTION

The invention relates to an autostereoscopic display device configured to display stereoscopic images as a stereoscopic movie. The invention further relates to a method for operating an autostereoscopic display device.

### BACKGROUND

Autostereoscopic displays play an increasingly important role in virtual reality and augmented reality applications. One of their most outstanding features is that they allow a viewer to perceive depth in the images they display, without the need for glasses or other dedicated eyewear. Moreover, this principle even works when the viewer moves relative to the autostereoscopic display.

Key to this technology is the presence of a screen that comprises a lenticular lens or a parallax barrier placed in front of an array of pixels. Due to the lenticular lens or parallax barrier, pixel output (i.e. light) can be directed to particular spatial directions, which allows selective illumination of only one eye of a pair of eyes. By accurately controlling the pixels, the screen can direct simultaneously a left eye image to a left eye of the viewer and a right eye image to a right eye of the viewer. The resulting stereoscopic image provides a depth perception wherein elements in the image may appear in front of the display or further away than the display (‘behind’ the display).

The performance of such autostereoscopic displays can be enhanced when the viewer's eye position relative to the display is tracked. The obtained position data improve the selectivity of the illumination of one eye of a pair of eyes, which on its turn decreases crosstalk (the undesired phenomenon that a portion of light intended for one eye ‘leaks’ to the other eye).

Such tracking is typically performed by an eye tracking system that operates at a certain rate, which is typically the image capture rate of a camera that forms part of the eye tracking system. This results in eye position data that become real-time available to the autostereoscopic display at the image capture rate, allowing an accurate and real-time adaptation of image display to viewer position.

The image display itself also occurs at a particular rate, which is the frame rate. This rate is preferably the same as the rate at which stereoscopic images are weaved to the display by a processor. Both rates are usually set at the same value (e.g. 60 Hz), as this allows the processor to run a regular process wherein the latest available eye position is used for the generation of each image frame.

It is however experienced with conventional autostereoscopic display devices that even when both frequencies are set at the same value, both frequencies may still fluctuate relative to one another. This appears to cause fluctuations in latency in certain cases. Also, when it is not possible to estimate the moment of image display to the user, the viewer's position at that moment of image display cannot be accurately predicted. This may lead to undesired position jitter and movement of displayed virtual objects. Another undesired effect is that the viewer can experience crosstalk when he moves relative to the display. A possible cause for the fluctuation of both frequencies relative to one another is a variation in external conditions such as temperature and/or voltage.

It is thus necessary to find a way to combat latency, in particular variations therein, and other disturbing effects caused by fluctuation of the frequencies of image capture and image display. To date, however, no satisfactory solution has been found to do so. It is for example unattractive to estimate for every frame when it will be displayed, as this requires feedback from the hardware (GPU/display) to the application, which is not easy to implement.

### SUMMARY OF THE INVENTION

It is therefore an object of the present invention to provide an improved autostereoscopic display with a decreased latency, in particular with a constant latency. It is also an object to provide a method for operating an autostereoscopic display device which exhibits less latency, in particular less fluctuations in latency.

It is more generally an object of the present invention to improve the viewing experience of a viewer of an autostereoscopic display device, which includes reducing the viewer's experience of crosstalk and improving the viewer's perception of displayed virtual objects with regard to their perceived position and/or movement.

It has now been found that one or more of these objects can be reached by introducing a particular rate matching means in the autostereoscopic display device. Accordingly, the present invention relates to an autostereoscopic display device (1) configured to display stereoscopic images as a stereoscopic movie thereby taking into account position data of a viewer (2) of the autostereoscopic display device (1) relative to the autostereoscopic display device (1), the autostereoscopic display device (1) comprising
a camera (3) configured to capture images of the viewer (2) at an image capture rate;
a viewer tracking system (4) configured to track the position of a viewer (2) relative to the autostereoscopic display device (1) by using the images obtained by the camera (3);
a display portion (5) configured to display the stereoscopic images at a display frame rate as a stereoscopic movie;
an image weaving unit (6) configured to weave stereoscopic images to the display portion (5) at a weaving frame rate by using position data of the viewer (2) relative to the autostereoscopic display device (1) obtained by the viewer tracking system (4);
a matching means (7) configured to match the image capture rate and the display frame rate.

The present invention further relates to a method for operating an autostereoscopic display device, the method comprising
capturing images of a viewer of the autostereoscopic display device at an image capture rate;
tracking the position of the viewer relative to the autostereoscopic display device by using the captured images;
weaving stereoscopic images to the display at a weaving frame rate by using position data of the viewer;
displaying the stereoscopic images at a display frame rate as a stereoscopic movie;
matching the image capture rate and the display frame rate.

### BRIEF DESCRIPTION OF THE DRAWINGS

FIG. 1 schematically displays two timelines that represent the image capture rate and the display frame rate in a conventional autostereoscopic display device.

FIG. 2 schematically displays two timelines that represent the image capture rate and the display frame rate in an autostereoscopic display device according to the invention.

FIG. 3 schematically displays an autostereoscopic display device (1) according to the invention.

### DETAILED DESCRIPTION OF THE INVENTION

The figures do not limit the present invention to the specific embodiments disclosed therein and described in the present description. Elements in the figures are illustrated for simplicity and clarity and have not necessarily been drawn to scale, emphasis instead being placed upon clearly illustrating the principles of the invention. For example, the representation of different rates (e.g. as their period) does not reflect their difference in a quantitative way.

In the context of the invention, by an autostereoscopic display device is meant a device configured to display a stereoscopic image to a viewer, wherein it simultaneously directs a left eye image to a left eye of the viewer and a right eye image to a right eye of the viewer. The viewer may so perceive a depth perception without using glasses or other dedicated eyewear. The left eye image and the right eye image together form a stereoscopic pair (i.e. a stereoscopic image).

A display portion of an autostereoscopic display device of the invention typically comprises an array of display pixel elements for producing a display output and a view-forming arrangement that is associated with the array.

Generally, the view-forming arrangement has a fixed connection with the pixel arrangement (i.e. both cannot move relative to one another). The view-forming arrangement is capable of directing the display output from different display pixel elements to different spatial positions within a field of view of the autostereoscopic display device to allow a simultaneous display of a left eye image and a right eye image. Usually, the view-forming arrangement comprises a lenticular lens or a parallax barrier.

In the context of the invention, by an image capture rate is meant a frequency at which repeated image capture occurs, typically expressed as a certain number of image captures per second. The time that elapses in a time period from a certain image capture until a subsequent image capture defines an image capture cycle.

Likewise, by a display frame rate is meant a frequency at which repeated image display occurs, typically expressed as a certain number of displayed frames per second. The time that elapses in a time period from a certain frame display until a subsequent frame display defines an image display cycle.

Likewise, by a weaving frame rate is meant a frequency at which repeated image weaving occurs, typically expressed as a certain number of weaved images per second. The time that elapses in a time period from a certain image weaving until a subsequent image weaving defines an image weaving cycle.

In the context of the invention, by the term “weaving” is meant a process wherein image pixels of a left eye image of a stereoscopic pair are assigned to display pixel elements of the autostereoscopic display device that direct their output to a left eye of a viewer and wherein image pixels of a right eye image of a stereoscopic pair are assigned to display pixel elements of the display device that direct their output to a right eye of a viewer.

In the field of autostereoscopic displays, weaving is a well-known concept for generating an output image by the autostereoscopic display on the basis of three-dimensional image input data. In prior art of the field, terms that are considered equivalent to weaving are, for example, “interleaving”, “interlacing” and “interdigitating”.

In an autostereoscopic display device of the invention, the weaving is performed in the image weaving unit. In practice, this unit is present in a personal computer (being part of the autostereoscopic display device) or in the display portion of the autostereoscopic display device (the image weaving unit is then integrated in the display portion). In the latter case, the weaving frame rate is usually synchronized with the display frame rate. For example, a completion of a particular image weaving automatically triggers an image display on the display portion, so that the weaving frame rate is the same as the display frame rate.

In the context of the invention, by the term “rendering” is meant the process of generating a stereoscopic image of a certain three-dimensional scene that corresponds to a particular viewpoint relative to the scene. Rendering may in principle be performed for any desired viewpoint of the three-dimensional scene. Subsequent display of the rendered stereoscopic image then requires weaving of the image. In this way, the viewer may perceive three-dimensional scene in three dimensions from a particular viewpoint (i.e. the viewpoint that was used for the rendering).

In the context of the invention, by the term “viewer” is meant a person in the real world who can consume, in particular view, content presented by an autostereoscopic display device. Throughout the text, references to the viewer will be made by male words like “he”, “him” or “his”. This is only for the purpose of clarity and conciseness, as it is understood that female words like “she”, and “her” equally apply.

Just as virtually any electronic device that functions through the input of data it acquires, an autostereoscopic display system suffers from latency. This is commonly understood as a time delay between user input and system response, also known as input lag. In the setting of an autostereoscopic display system according to the invention, this basically means that there is a delay between movement of the viewer's head/eye (user input) and adaptations to displayed content in response thereto (system response). Latency then manifests as incorrect rendering of stereoscopic images. It may also cause crosstalk when a left eye image is for a part also directed at a right eye of the viewer, and vice versa. If latency exceeds a critical threshold, user performance and experience get impaired. This usually concerns a disturbed look around effect and/or crosstalk. For example, a displayed object is not perceived at the correct position, at least temporarily.

The inventors realized that setting both the image capture rate and the display frame rate at the same value does not guarantee that both frequencies are indeed exactly the same. This manifests as a time offset between image capture events and frame display events that varies over time. This means that in a certain time period, the number of image capture cycles does not equal the number of image display cycles. For example, in the course of one minute, there may be a difference of a few cycles. Moreover, the extent of such difference is neither constant in time.

It is contemplated that external conditions like temperature variation and voltage variation are responsible for this, which are known influencers of the output frequency of crystal oscillators that are used to set frequencies in electronic equipment (known as frequency stability).

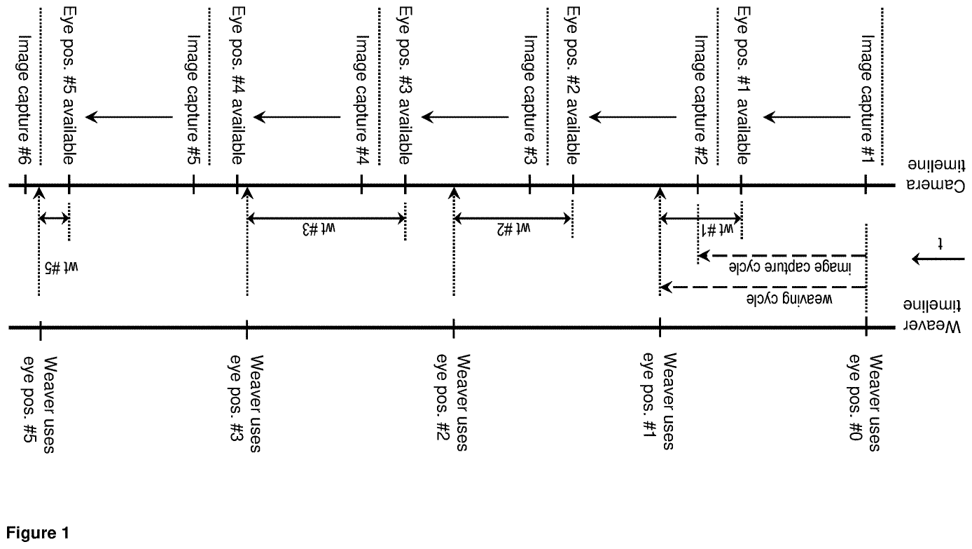

The effect of a slight variation in both frequencies is demonstrated in FIG. 1. It shows an upper timeline with events occurring at a weaving frame rate, which events represent the moments where an available eye position is used by the weaver. As is usually the case, the weaving frame rate is the same rate as the display frame rate of the autostereoscopic display device. Also shown is a lower timeline with events occurring at an image capture rate, which events represent the moments of an image capture and the moments where an eye position becomes available to the weaver. The difference in frequencies is visualized in FIG. 1 by the length of their respective cycles, as the weaving cycle is longer than the image capture cycle.

It can be seen in FIG. 1 that some time elapses before an available eye position is used by the weaver, which is the waiting time (indicated with wt #1, wt #2, etc.). It can also be seen that the waiting time varies from cycle to cycle due to the difference between the length of the weaving cycle and the length of the image capture cycle. These lengths follow from the difference in the weaving frame rate (same as the display frame rate) and the image capture rate. FIG. 1 also reveals that some eye positions are not even used by the weaver, because the waiting time has become so long that a new eye position has become available in the meantime. It is the varying waiting time that causes problems with conventional autostereoscopic display devices, such as fluctuations in latency, inaccurate prediction of viewer position, position jitter, movement of displayed virtual objects and crosstalk when the viewer moves relative to the display.

The present invention solves this problem by the introduction of a matching means in the autostereoscopic display device, which enforces a relation between both frequencies that does not allow that one drifts away from the other over time. Herein, it is the display portion that dictates its display frame rate to the camera, so that the camera adopts that rate for its image capture rate. The matching means is therefore typically configured to trigger the camera at a rate that equals the display frame rate.

One way of matching the image capture rate and the display frame rate is to use the vsync signal of the display portion. The vsync signal marks the start of a frame by lighting the first pixel of a frame. This signal can also be used to trigger the shutter of the camera, which has the effect that there is a fixed relation between the start of a new frame and an image capture. Therefore, the matching means in an autostereoscopic display device of the invention may comprise a communication means between the display portion on the one hand and the camera on the other hand, for example an electrical communication, an electronic communication or an optical communication. This can be implemented by connecting one end of a wire to a vsync output pin of the display portion and another end of the wire to an input means on the camera. The electrical communication may also be wireless.

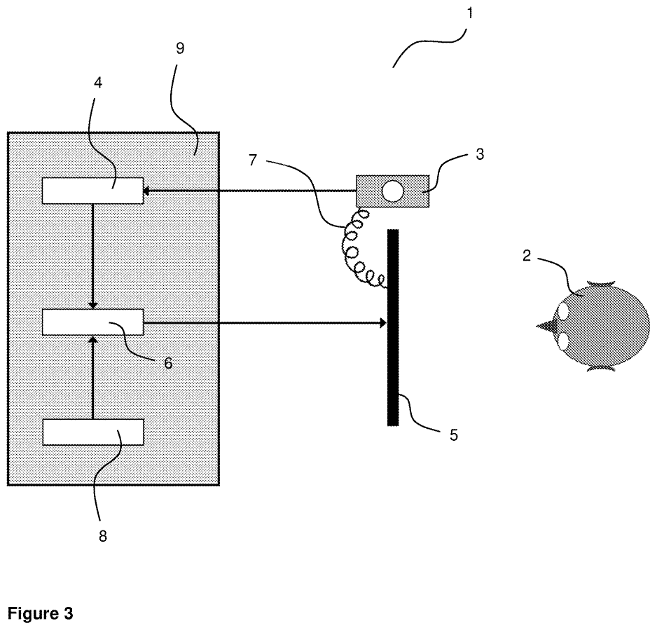

FIG. 3 schematically displays an autostereoscopic display device (1) according to the invention, where a viewer (2) views a stereoscopic movie that is displayed by the autostereoscopic display device (1). The position of the viewer (2) relative to the autostereoscopic display device (1) is tracked by a viewer tracking system (4) which receives images of the viewer (2) that are captured by a camera (3) at an image capture rate. An image weaving unit (6) is present which receives image data from image data storage unit (8) and which receives position data of the viewer (2) from the viewer tracking system (4). The image weaving unit (6) weaves the image data for display on the display portion (5) at a weaving frame rate. To this end, the display portion (5) receives the weaved images from the image weaving unit (6) and displays these as a stereoscopic movie to the viewer (2). Also present is a matching means (7), which matches, during the display of the stereoscopic movie, the image capture rate and the display frame rate. In this particular embodiment, the matching means (7) is a wire between a vsync output pin of the display portion (5) and an input means of the camera (3). In the autostereoscopic display device (1) of FIG. 1, the viewer tracking system (4), the image weaving unit (6) and the image data storage unit (8) are all part of a processor (9), for example a personal computer.

When the two rates are matched, then another property enters the stage: phase difference. Both rates have a period, which is in the context of the present invention identified as a cycle. The image capture cycle may be offset with respect to the image display cycle, which means that image capture all along occurs a certain time after image display has occurred. Such delay in the occurrence of image capture with respect to image display is known as an offset or phase difference. The sheer presence of a communication between the display portion and the camera just matches both rates and results in an offset that is neither chosen nor adapted.

Any adaptation of a phase difference is however possible by delaying the arrival of a signal from the display portion at the camera. To his end, the matching means comprises an adaptation means that is configured to adapt a phase difference between image capture cycles and image display cycles to a desired value. Such adaptation means for example comprises a signal delay unit.

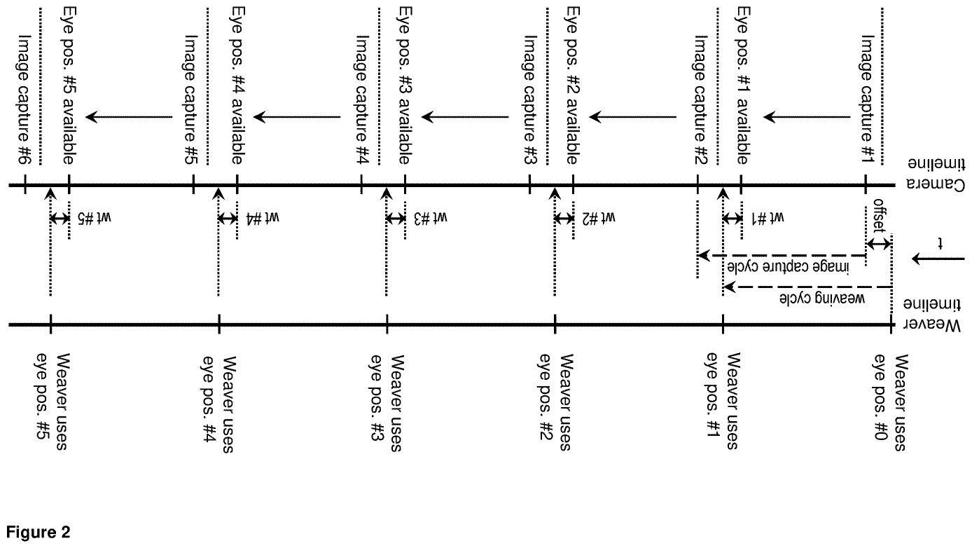

FIG. 2 demonstrates the effect of the invention when 1) both frequencies match; and 2) the phase difference is adapted. The matching frequencies are visualized in FIG. 2 by the length of their respective cycles, as the weaving cycle is as long as the image capture cycle. The phase difference is adapted in such way that the waiting time is very short (so as to e.g. arrive at a reduced and constant latency) but not too short (so as to be sure that no eye position becomes available too late). Thus, this embodiment demonstrates that a method of the invention results in a reduced latency of the autostereoscopic display device.

In an autostereoscopic display device of the invention, the viewer tracking system is typically an eye tracking system.

A method of the invention may comprise adapting a phase difference between image capture cycles and image display cycles to a desired value, wherein an image capture cycle represents one period of the image capture rate and an image display cycle represents one period of the display frame rate.

The adaptation of a phase difference may advantageously be used to reduce a waiting time in the autostereoscopic display device. Such waiting time is typically a period of time that lapses between
a first point in time at which position data of the viewer relative to the autostereoscopic display device have become available; and
a second point in time, being later than the first point in time, at which the position data of the viewer relative to the autostereoscopic display device are actually used by an application running on the autostereoscopic display device, for which application the position data are intended.

Such application is for example an application that comprises an image weaving portion configured to weave stereoscopic images to the display portion.

Such application may also be an application that comprises an image rendering portion configured to render stereoscopic images for display on the autostereoscopic display device.

The reduction of the waiting time as explained above on its turn results in a reduced latency of the autostereoscopic display device.

In a method or autostereoscopic display device according to the invention, the image capture rate and the display frame rate both have the same value, which value is preferably selected from the group of 60 Hz, 90 Hz, 100 Hz, 120 Hz, 144 Hz, 165 Hz and 200 Hz.

In an embodiment, the autostereoscopic display device comprises a processor and a memory, wherein the memory comprises computer-executable code that, when executed by the processor, causes the processor to perform the method for operating an autostereoscopic display device as described above.

The invention further relates to a computer readable medium comprising transitory or non-transitory data representing instructions to cause a processor system to perform the method for operating an autostereoscopic display device as described above.

The invention further relates to software arranged to perform the method for operating an autostereoscopic display device as described above, when executed on a computer.

1-17. (canceled)

18. An autostereoscopic display device, comprising:
a camera configured to capture images of a viewer at an image capture rate;
a viewer tracking system configured to track a position of the viewer relative to the autostereoscopic display device, as position data, using the images obtained by the camera;
a display portion configured to display stereoscopic images at a display frame rate as a stereoscopic movie;
an image weaving unit configured to weave the stereoscopic images for display on the display portion at a weaving frame rate based on the position data; and
a matching unit configured to match the image capture rate and the display frame rate.

19. The autostereoscopic display device of claim 18, wherein the matching unit is configured to trigger the camera at a rate equal to the display frame rate.

20. The autostereoscopic display device of claim 18, wherein the matching unit is configured to communicate between the display portion and the camera via at least one of an electrical communication, an electronic communication, or an optical communication.

21. The autostereoscopic display device of claim 18, wherein:
the matching unit is configured to set a phase difference between image capture cycles and image display cycles to a desired value;
an image capture cycle represents one period of the image capture rate; and
an image display cycle represents one period of the display frame rate.

22. The autostereoscopic display device of claim 21, wherein the matching unit comprises a signal delay unit.

23. The autostereoscopic display device of claim 18, wherein the viewer tracking system is an eye tracking system.

24. The autostereoscopic display device of claim 18, wherein the weaving frame rate equals the display frame rate.

25. A method for operating an autostereoscopic display device, comprising:
capturing images of a viewer of the autostereoscopic display device at an image capture rate;
tracking a position of the viewer relative to the autostereoscopic display device using the captured images;
weaving stereoscopic images for a display portion of the autostereoscopic display device at a weaving frame rate using position data of the viewer;
displaying the stereoscopic images by the display portion at a display frame rate as a stereoscopic movie; and
matching the image capture rate and the display frame rate by enforcing a relation between the image capture rate and the display frame rate that prevents the image capture rate and the display frame rate from diverging over time.

26. The method of claim 25, further comprising setting a phase difference between image capture cycles and image display cycles to a desired value, wherein an image capture cycle represents one period of the image capture rate and an image display cycle represents one period of the display frame rate.

27. The method of claim 26, wherein setting the phase difference reduces a waiting time between:
a first point in time at which the position data of the viewer relative to the autostereoscopic display device becomes available; and
a second point in time, later than the first point in time, at which the position data of the viewer relative to the autostereoscopic display device is used by an application running on the autostereoscopic display device.

28. The method of claim 27, wherein the application comprises an image weaving portion configured to weave stereoscopic images for the display portion.

29. The method of claim 27, wherein the application comprises an image rendering portion configured to render stereoscopic images for display on the autostereoscopic display device.

30. The method of claim 27, wherein reducing the waiting time reduces a latency of the autostereoscopic display device.

31. The method of claim 25, wherein the weaving frame rate and the display frame rate are equal.

32. The method of claim 25, wherein the image capture rate and the display frame rate are equal.

33. The method of claim 32, wherein the image capture rate and the display frame rate are one of 60 Hz, 90 Hz, 100 Hz, 120 Hz, 144 Hz, 165 Hz, or 200 Hz.

34. A non-transitory computer-readable medium comprising instructions that, when executed by a processor, cause the processor to perform the method of claim 25.

35. A computer program product comprising instructions that, when executed by a processor, cause the processor to perform the method of claim 25.
